(19) United States
(12) Patent Application Publication
(10) Pub. No.: US 2026/0162174 A1
(43) Pub. Date: Jun. 11, 2026

(54) SYSTEM AND METHOD FOR SEAMLESS TRANSITIONING OF ACCOUNTS

(71) Applicant: JPMorgan Chase Bank, N.A., New York, NY (US)

(72) Inventors: Himant ARUN, Frisco, TX (US); Madhur AGARWAL, Oak Point, TX (US); Zhiliang XIE, Dallas, TX (US); Hong YANG, Princeton, FL (US); Toni AVILA, Lewisville, TX (US); Jeetesh GOYAL, Hyderabad (IN); Manohar KHAGGA, Ongole (IN); Jalender PANJALA, Jagtial (IN); Rajan DOMALA, Hyderabad (IN); Ravi V KANTH, Hyderabad (IN); Dharmesh CHAVDA, Frisco, TX (US); Sreejith SREEKUMARAN, Garnet Valley, PA (US); Matt HINNENKAMP, Dallas, TX (US); Marjorie URBINA, Katy, TX (US)

(73) Assignee: JPMorgan Chase Bank, N.A., New York, NY (US)

(21) Appl. No.: 19/035,151

(22) Filed: Jan. 23, 2025

(30) Foreign Application Priority Data
Dec. 11, 2024 (IN) 202411097855

(51) Int. Cl. G06Q 40/02; G07F 19/00; H04L 9/40

(52) U.S. Cl. CPC G06Q 40/02; H04L 63/0861; G07F 19/206

(57) ABSTRACT

Various methods and processes, apparatuses or systems, and media for providing a seamless graduation of a restricted account are disclosed. The present disclosure provides scanning, one or more databases, for identifying a potential account for graduation, performing one or more prequalification checks on the potential account for graduation for determining whether the potential account is a graduation eligible account, and identifying an authorizing user for the graduation eligible account. Upon identification of the graduation eligible account, capturing a consent of the authorizing user for authorizing graduation of the graduation eligible account, and converting the graduation eligible account into a graduated account, in which the graduated account is a modification of the graduation eligible account that is existing in a network database.

### CROSS-REFERENCE TO RELATED APPLICATION

This application claims priority benefit from Indian Application No. 202411097855, filed Dec. 11, 2024, which is hereby incorporated by reference in its entirety.

### TECHNICAL FIELD

This disclosure generally relates to converting a restricted account to reflect a change in status of a user without requiring a closure of an existing account.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

For younger segment of the population, an account created with an organization may have differing or limited levels of access and capabilities due to not yet reaching legal status in their respective jurisdiction. Once a person reaches a legal status (e.g., age of eighteen in the United States), the respective person may be legally allowed to perform various transactions with the organization, which may have been unavailable as a minor, and may seek to convert his or her previous minor account to an adult account or otherwise unrestricted account.

Conversions of a minor account to an adult account conventionally required physically appearing at a designated facility with both the minor and legal guardian, closing of the minor account under one account number and opening a new adult account under a different account number as the existing account numbers for the minor account may not be utilized for opening a new account. Accordingly, at least two accounts with two account numbers may be generated and stored for every minor that transitions to a legal adult. Accordingly, as multiple accounts remaining in the system may in turn may cause duplicate events to be generated when a transaction is made by the account holder, leading to unnecessary expenditure of computing resources with less efficient processing.

Further, during the conventional conversions of accounts, many new accounts may be required to be shut down if other account requirements are later found to be lacking, such as sufficient value (e.g., minimum funds) indicated in the respective account. In such a scenario, the person in question may be temporarily left without any account access to his or her former account or the new account, and may require another account to be created at a later time under a new account number while reverting back to the old account, requiring multiple computing transactions to be performed.

Given the large number of account creations and deletions required for conventional account conversions, a more robust memory storage may be required.

### SUMMARY

The present disclosure, through one or more of its various aspects, embodiments, and/or specific features or sub-components, provides, among other features, a method for providing a seamless graduation of a restricted account is provided. The method includes scanning, one or more databases by a processor, for identifying a potential account for graduation based on a date of birth (DOB) data of an account holder; performing, by the processor, one or more prequalification checks on the potential account for graduation for determining whether the potential account is a graduation eligible account; identifying, by the processor, an authorizing user for the graduation eligible account; notifying, by the processor via a digital communication service, the authorizing user of graduation eligibility of the graduation eligible account and requesting to receive consent from the authorizing user; capturing, by the processor, the consent of the authorizing user for authorizing graduation of the graduation eligible account; converting, by the processor, the graduation eligible account into a graduated account, in which the graduated account is a modification of the graduation eligible account that is existing in a network database; and terminating, by the processor, access to the graduated account by the authorizing user.

In some embodiments, the scanning is performed in accordance with a predetermined frequency.

In some embodiments, the potential account for graduation is identified based on a current date and the DOB of the account holder of the potential account.

In some embodiments, the scanning for identifying the potential account for graduation is performed in response to an automated teller machine (ATM) transaction or one or more actions on a mobile application conducted by the account holder.

In some embodiments, the authorizing user is set as an owner of the graduation eligible account.

In some embodiments, the authorizing user is a legal guardian of the account holder.

In some embodiments, the authorizing user provides the consent via an ATM, and wherein the ATM performs verification of the authorizing user using a plurality of sensors prior to receiving of the consent. In other embodiments, the authorizing user provides the consent via a mobile application.

In some embodiments, the method further includes notifying, by the processor, the account holder of a performance of the notifying of the authorizing user.

In some embodiments, the method further includes saving, in permanence and by the processor in the network database, captured consent of the authorizing user.

In some embodiments, the converting further includes changing the account holder to be set as the owner; and terminating relationship of the authorizing user from the graduation eligible account.

In some embodiments, the converting is performed without creating a new account or deleting an existing account.

In some embodiments, the graduation eligible account removes at least one restriction from the graduation eligible account.

In some embodiments, the converting further includes terminating, by the processor, a management application tied to the graduation eligible account.

In some embodiments, the one or more prequalification checks includes checking of a presence of a predetermined amount of deposit.

In some embodiments, the one or more prequalification checks includes checking of a duration of residency. In other embodiments, the one or more prequalification checks includes checking of that the graduation eligible account has been active for at least a predetermined period of time.

In some embodiments, the plurality of sensors includes a biometric reader.

In some embodiments, the plurality of sensors includes an image sensor and a microphone.

In some embodiments, the graduation eligible account is a restricted account that was created prior to the account holder reaching a predetermined age.

In some embodiments, a system for providing a seamless graduation of a restricted account is disclosed. The system may include: a processor; and a memory operatively connected to the processor via a communication interface, the memory storing computer readable instructions, when executed, causes the processor to perform: scanning, one or more databases, for identifying a potential account for graduation based on a DOB data of an account holder; performing one or more prequalification checks on the potential account for graduation for determining whether the potential account is a graduation eligible account; identifying an authorizing user for the graduation eligible account; notifying, via a digital communication service, the authorizing user of graduation eligibility of the graduation eligible account and requesting to receive consent from the authorizing user; capturing the consent of the authorizing user for authorizing graduation of the graduation eligible account; converting the graduation eligible account into a graduated account, in which the graduated account is a modification of the graduation eligible account that is existing in a network database; and terminating access to the graduated account by the authorizing user.

In some embodiments, a non-transitory computer readable medium configured to store instructions for providing a seamless graduation of a restricted account is disclosed. The instructions, when executed, may cause a processor to perform the following: scanning, one or more databases, for identifying a potential account for graduation based on a DOB data of an account holder; performing one or more prequalification checks on the potential account for graduation for determining whether the potential account is a graduation eligible account; identifying an authorizing user for the graduation eligible account; notifying, via a digital communication service, the authorizing user of graduation eligibility of the graduation eligible account and requesting to receive consent from the authorizing user; capturing the consent of the authorizing user for authorizing graduation of the graduation eligible account; converting the graduation eligible account into a graduated account, in which the graduated account is a modification of the graduation eligible account that is existing in a network database; and terminating access to the graduated account by the authorizing user.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a seamless graduation system in accordance with an embodiment.

FIG. 2 illustrates a diagram of a network environment for implementing a seamless graduation system in accordance with an embodiment.

FIG. 3 illustrates a system configuration diagram for implementing a seamless graduation system in accordance with an embodiment.

FIG. 4 illustrates a method for providing a seamless graduation of a restricted account in accordance with an embodiment.

FIG. 5 illustrates system flows of a seamless graduation system for converting a restricted account to an unrestricted or less restricted account in accordance with an embodiment.

FIGS. 6A-6B illustrate system flows for performing data loading operation in accordance with an embodiment.

FIGS. 7A-7D illustrate system flows for performing prequalification check operation in accordance with an embodiment.

FIGS. 8A-8F illustrate system flows for obtaining and processing a consent of an authorizing user or guardian in accordance with an embodiment.

FIGS. 9A-9B illustrate system flows for performing a graduation of an eligible account in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As noted above, conventional conversion of an age restricted account to an unrestricted account requires closure of the age restricted account and opening of a new account in a database. The closure of one account and opening of another account require additional computing resources than simply maintaining a single account. Moreover, at least since the two accounts for each account holder may remain in the database, unnecessary memory storage may be expanded. Also, since the new account may be stored at a different memory location than the existing account, accessing two separate accounts in two different memory storage locations may cause retrieval of information to be slower than for a single existing account. Further still, because the conventional conversion requires two separate accounts, continuity from one account to the next may be lacking, which may require retrieval of both accounts to view continuity between the two accounts.

In consideration of the above noted technological drawbacks and limitations, exemplary aspects of the present disclosure provide a novel seamless graduation system and method specifically configured for converting an existing restricted account to an unrestricted account without requiring closure of the existing account and without opening a new account in a database by modifying one or more attributes of the existing account and by facilitating a digitally obtained consent from an authorizing guardian. Based on such features, continuity of information may be retained in a single account for more efficient data retrieval and utilization of computing resources.

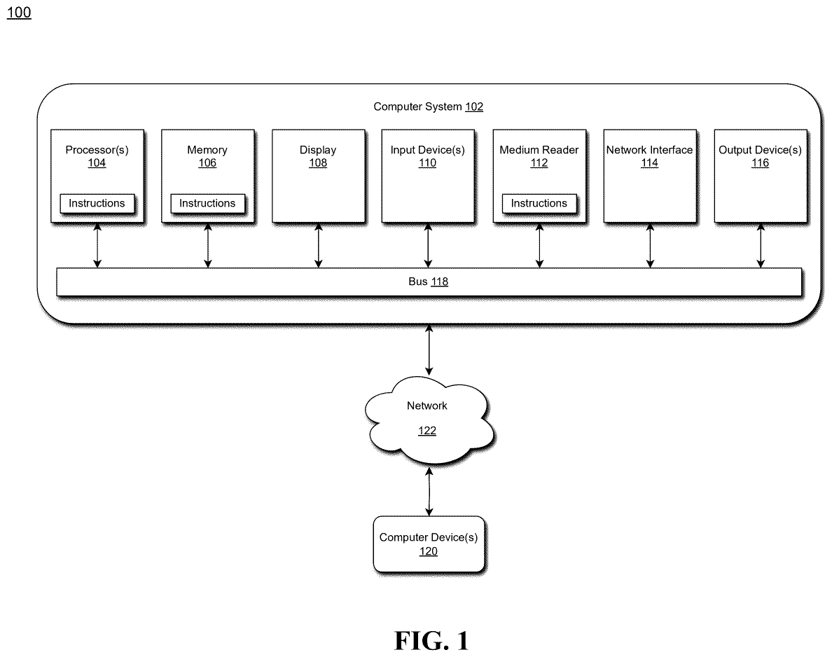

FIG. 1 is a system 100 for use in implementing a seamless graduation system in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the seamless graduation module implemented by the system 100 may allow for a seamless graduation module configured to perform scanning, one or more databases, for identify a potential account for graduation based on a date of birth (DOB) data of an account holder; perform one or more prequalification checks on the potential account for graduation for determining whether the potential account is a graduation eligible account; identify an authorizing user for the graduation eligible account; notify, via a digital communication service, the authorizing user of graduation eligibility of the graduation eligible account and requesting to receive consent from the authorizing user; capture the consent of the authorizing user for authorizing graduation of the graduation eligible account; and terminate access to the graduated account by the authorizing user.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

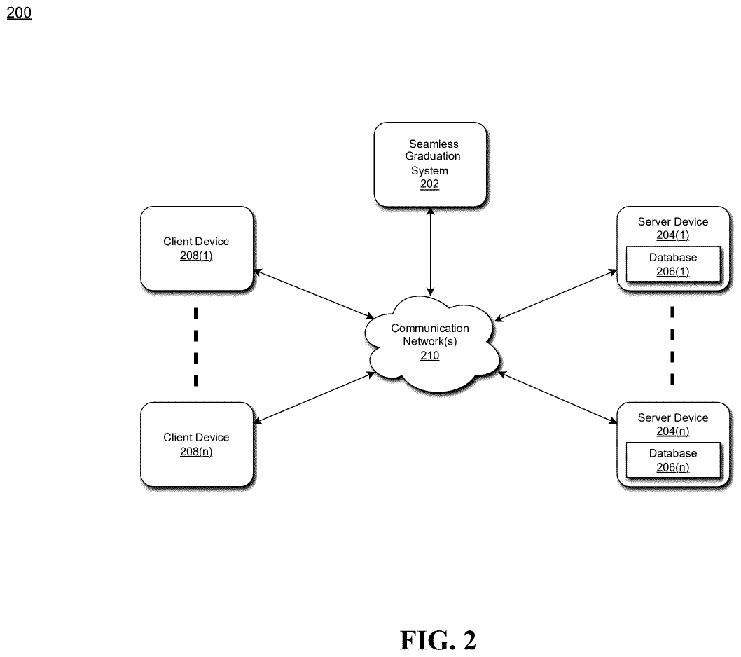

Referring to FIG. 2, a schematic of a network environment 200 for implementing a seamless graduation system is illustrated.

In some embodiments, the above-described problems associated with conventional conversion process of existing accounts may be overcome by implementing a seamless graduation system 202 as illustrated in FIG. 2 that may be configured for implementing a seamless graduation module configured for scanning, one or more databases, for identifying a potential account for graduation based on a DOB data of an account holder; performing one or more prequalification checks on the potential account for graduation for determining whether the potential account is a graduation eligible account; identifying an authorizing user for the graduation eligible account; notifying, via a digital communication service, the authorizing user of graduation eligibility of the graduation eligible account and requesting to receive consent from the authorizing user; capturing the consent of the authorizing user for authorizing graduation of the graduation eligible account; converting the graduation eligible account into a graduated account, wherein the graduated account is a modification of the graduation eligible account that is existing in a network database; and terminating access to the graduated account by the authorizing user.

The seamless graduation system 202 may include one or more computer system 102s, as described with respect to FIG. 1, which in aggregate provides the necessary functions.

The seamless graduation system 202 may store one or more applications that can include executable instructions that, when executed by the seamless graduation system 202, cause the seamless graduation system 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the seamless graduation system 202 itself, may be located in virtual server(s) running in a cloud-based computing environment rather than being tied to one or more specific physical network computing devices. Also, the application(s) may be running in one or more virtual machines (VMs) executing on the seamless graduation system 202. Additionally, in one or more embodiments of this technology, virtual machine(s) running on the seamless graduation system 202 may be managed or supervised by a hypervisor.

In the network environment 200 of FIG. 2, the seamless graduation system 202 may be coupled to a plurality of server devices 204(1)-204(n) that hosts a plurality of databases 206(1)-206(n), and also to a plurality of client devices 208(1)-208(n) via communication network(s) 210. A communication interface of the seamless graduation system 202, such as the network interface 114 of the computer system 102 of FIG. 1, operatively couples and communicates between the seamless graduation system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the seamless graduation system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The seamless graduation system 202 may be a standalone device or integrated with one or more other devices or apparatuses, such as one or more of the server devices 204(1)-204(n), for example. In one particular example, the seamless graduation system 202 may be hosted by one of the server devices 204(1)-204(n), and other arrangements are also possible. Moreover, one or more of the devices of the seamless graduation system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the seamless graduation system 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the seamless graduation system 202 that may efficiently provide a seamless graduation module configured for scanning, one or more databases, for identifying a potential account for graduation based on a DOB data of an account holder; performing one or more prequalification checks on the potential account for graduation for determining whether the potential account is a graduation eligible account; identifying an authorizing user for the graduation eligible account; notifying, via a digital communication service, the authorizing user of graduation eligibility of the graduation eligible account and requesting to receive consent from the authorizing user; capturing the consent of the authorizing user for authorizing graduation of the graduation eligible account; converting the graduation eligible account into a graduated account, wherein the graduated account is a modification of the graduation eligible account that is existing in a network database; and terminating access to the graduated account by the authorizing user.

The client devices 208(1)-208(n) may run interface applications, such as standard web browsers or standalone client applications, which may provide an interface to communicate with the seamless graduation system 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the seamless graduation system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the seamless graduation system 202, the server devices 204(1)-204(n), or the client devices 208(1)-208(n), for example, may be configured to operate as virtual instances on the same physical machine. For example, one or more of the seamless graduation system 202, the server devices 204(1)-204(n), or the client devices 208(1)-208(n) may operate on the same physical device rather than as separate devices communicating through communication network(s) 210. Additionally, there may be more or fewer seamless graduation system s 202, server devices 204(1)-204(n), or client devices 208(1)-208(n) than illustrated in FIG. 2. In some embodiments, the seamless graduation system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

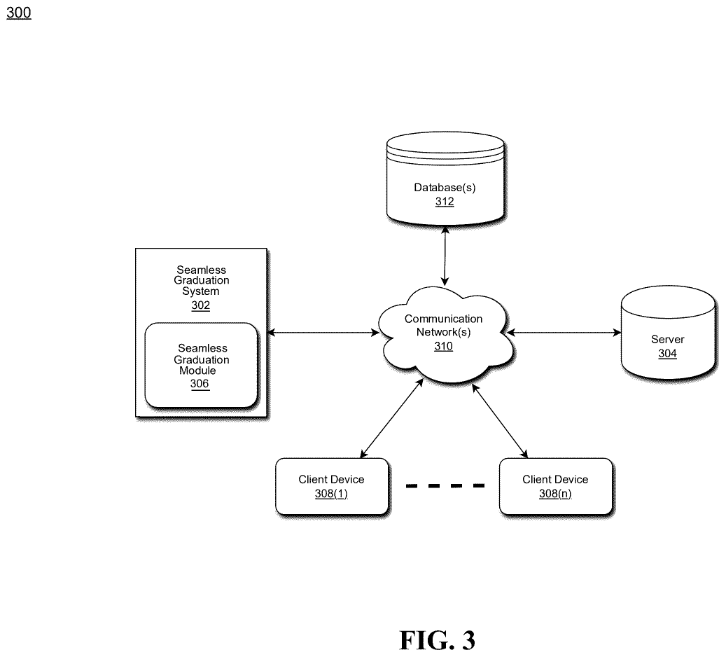

FIG. 3 illustrates a system diagram for implementing a seamless graduation system in accordance with an embodiment.

As illustrated in FIG. 3, the system 300 may include a seamless graduation system 302 within which a seamless graduation module 306 is embedded, a server 304, a database(s) 312, a plurality of client devices 308(1) . . . 308(n), and a communication network 310.

In some embodiments, the seamless graduation system 302 including the seamless graduation module 306 may be connected to the server 304, and the database(s) 312 via the communication network 310. The seamless graduation system 302 may also be connected to the plurality of client devices 308(1) . . . 308(n) via the communication network 310, but the disclosure is not limited thereto. The database(s) 312 may include one or more rule databases.

In an embodiment, the seamless graduation system 302 is described and shown in FIG. 3 as including the seamless graduation module 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store tables, atomic steps generated from queries, intermediate output or tables, corresponding attribution maps, association between one or more atomic steps and corresponding intermediate output or tables, and corresponding table attributes.

In some embodiments, the seamless graduation module 306 may be configured to receive real-time feed of data from the plurality of client devices 308(1) . . . 308(n) and secondary sources via the communication network 310.

The seamless graduation module 306 may be configured to perform scanning, one or more databases, for identifying a potential account for graduation based on a DOB data of an account holder; performing one or more prequalification checks on the potential account for graduation for determining whether the potential account is a graduation eligible account; identifying an authorizing user for the graduation eligible account; notifying, via a digital communication service, the authorizing user of graduation eligibility of the graduation eligible account and requesting to receive consent from the authorizing user; capturing the consent of the authorizing user for authorizing graduation of the graduation eligible account; converting the graduation eligible account into a graduated account, wherein the graduated account is a modification of the graduation eligible account that is existing in a network database; and terminating access to the graduated account by the authorizing user.

The plurality of client devices 308(1) . . . 308(n) are illustrated as being in communication with the seamless graduation system 302. In this regard, the plurality of client devices 308(1) . . . 308(n) may be “clients” (e.g., customers) of the seamless graduation system 302 and are described herein as such. Nevertheless, it is to be known and understood that the plurality of client devices 308(1) . . . 308(n) need not necessarily be “clients” of the seamless graduation system 302, or any entity described in association therewith herein. Any additional or alternative relationship may exist between either or both of the plurality of client devices 308(1) . . . 308(n) and the seamless graduation system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the seamless graduation system 302 via broadband or cellular communication. Of course, these embodiments are merely exemplary and are not limiting or exhaustive.

The client devices 308(1) . . . 308(n) may be the same or similar to any one of the client devices 208(1)-208(n) as described with respect to FIG. 2, including any features or combination of features described with respect thereto. The seamless graduation system 302 may be the same or similar to the seamless graduation system 202 as described with respect to FIG. 2, including any features or combination of features described with respect thereto.

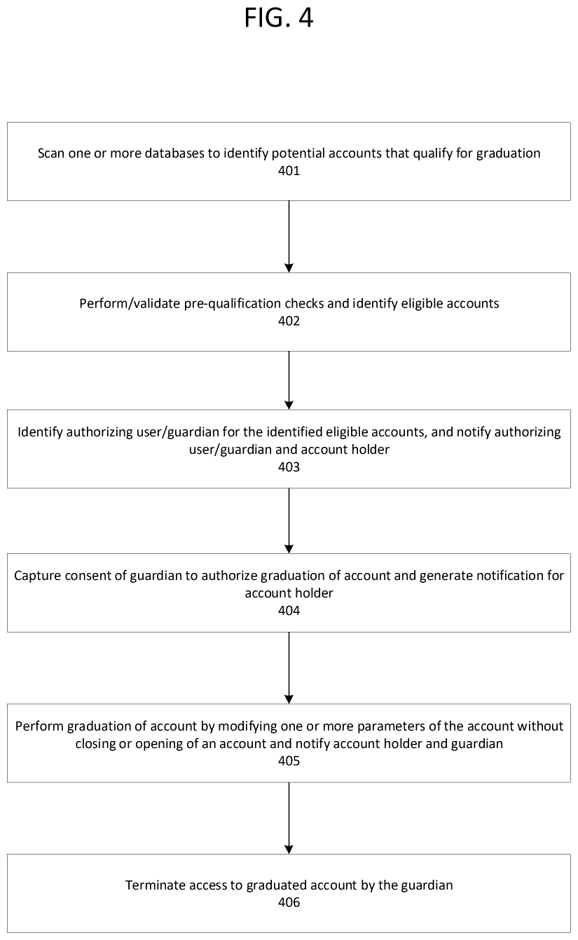

FIG. 4 illustrates a method for providing a seamless graduation of a restricted account in accordance with an embodiment.

In operation 401, one or more databases may be scanned to identify one or more potential accounts that may qualify for graduation. In an example, the scanning process may be performed by a centralized account management device (CAMD), which may be a part of the seamless graduation system. The centralized account management device may be connected to various compute services, APIs and other network components for facilitating the account graduation process. The centralized account management device may also be connected to a network database for storing various values during the graduation process, such as consent, lifecycle status, prequalification status, age status, and the like. The centralized account management device may also store the various values internally in its tables. In further examples, the databases being scanned may be a single database or a network of databases that may be distributed across a network or networks.

In an example, the one or more databases may be scanned at predetermined intervals, at scheduled dates or times, or in response to an input or trigger signal. However, aspects of the present disclosure are not limited thereto, such that such restricted accounts may trigger a signal when an attribute in such accounts meets a set requirement. For example, current date matching eighteenth birthday of an account holder of an age restricted account. Further, the scanning of the databases may be triggered in response to a certain event, such as a usage of an automated teller machine (ATM) for performing an ATM transaction, logging into an application or the like. Moreover, when the use of ATM triggers the scanning operation, user verification data collected at the ATM may be leveraged for verification of the account holder.

According to exemplary aspects, potential accounts that may qualify for graduation may refer to restricted accounts that may be limited in performing one or more operations due to regulatory or systematic reasons. For example, the restricted account may be restricted based on age, citizenship, residency or other attributes. Although restrictions with respect to legal status have been described herein, aspects of the present disclosure are not limited thereto such that restriction may be placed with respect to other qualifiers or status.

In an example, the restricted accounts may be an age restricted account, such as a bank account, driver license, voter registration or the like. However, aspects of the present disclosure are not limited thereto, such that the restricted accounts may be residency restricted account, citizenship restricted account, a combination of various restrictions (e.g., age and residency), or the like.

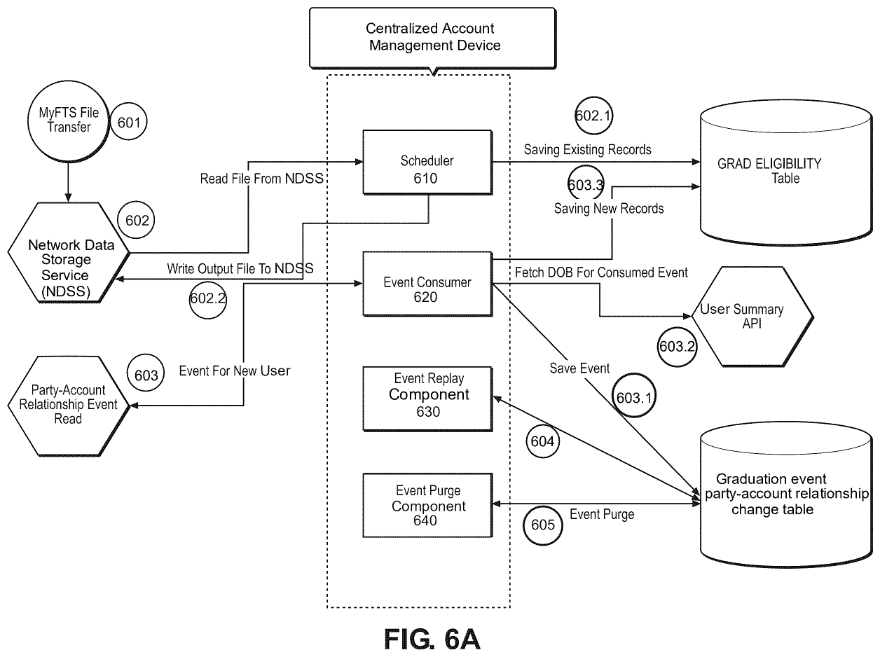

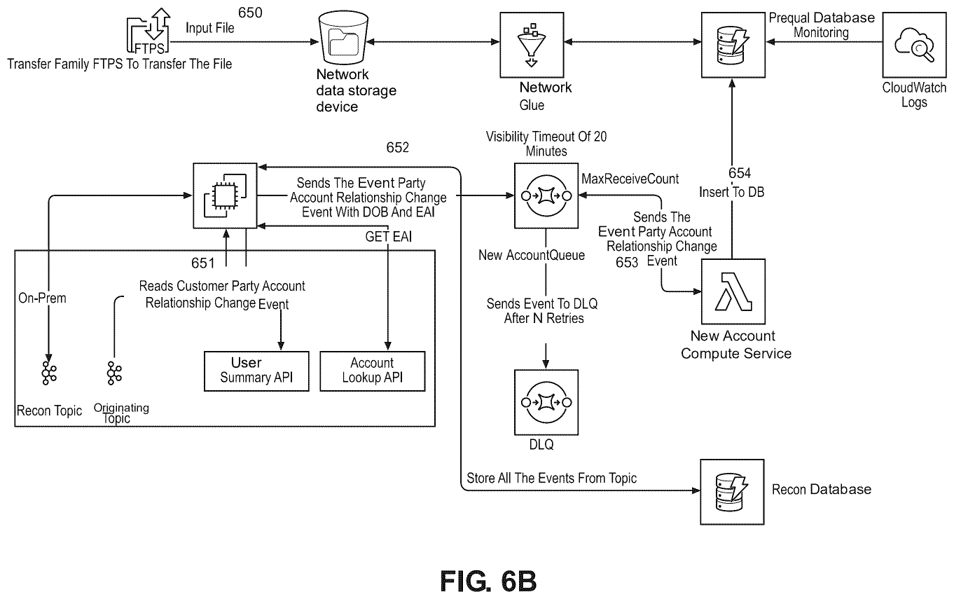

Detailed descriptions of an example data loading of potential accounts that may qualify for graduation are provided with respect to FIGS. 6A-6B below.

In operation 402, one or more pre-qualification checks may be performed and validated for identifying graduation eligible accounts (GEA) among the identified potential accounts. Although the age may trigger a search for the potential accounts that qualify for graduation, additional requirements (i.e., prequalification requirements) may be present in order to initiate the graduation process. In an example, the prequalification checks may be performed on a predetermined frequency until all of the prequalification requirements are met. According to aspects of the present disclosure, prequalification requirements may include, without limitation, a current mailing address, an amount of deposit, a duration of residency, title or position in an occupation, age of the graduation eligible account and the like.

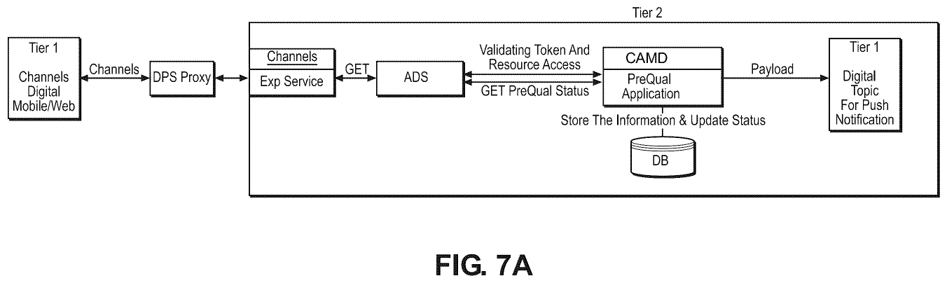

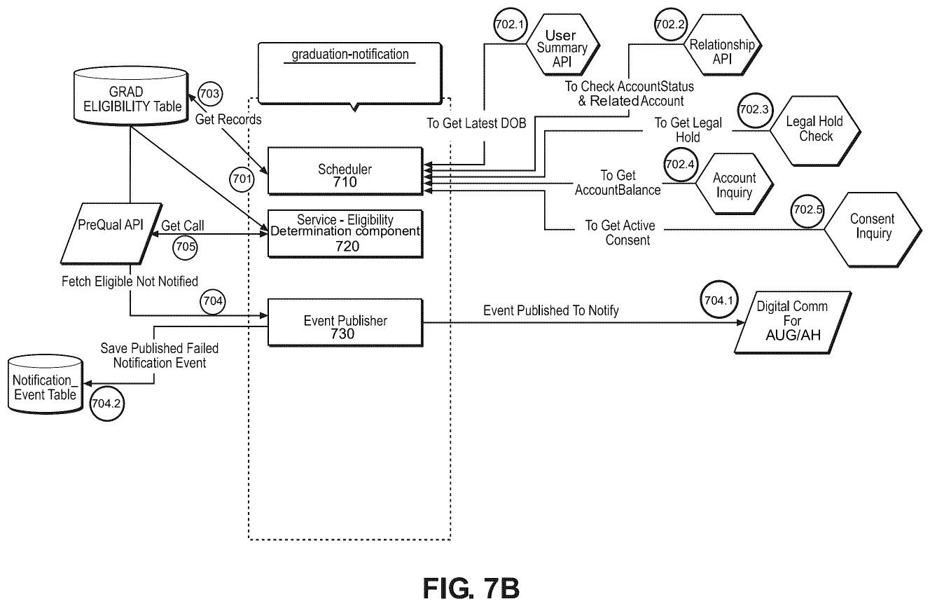

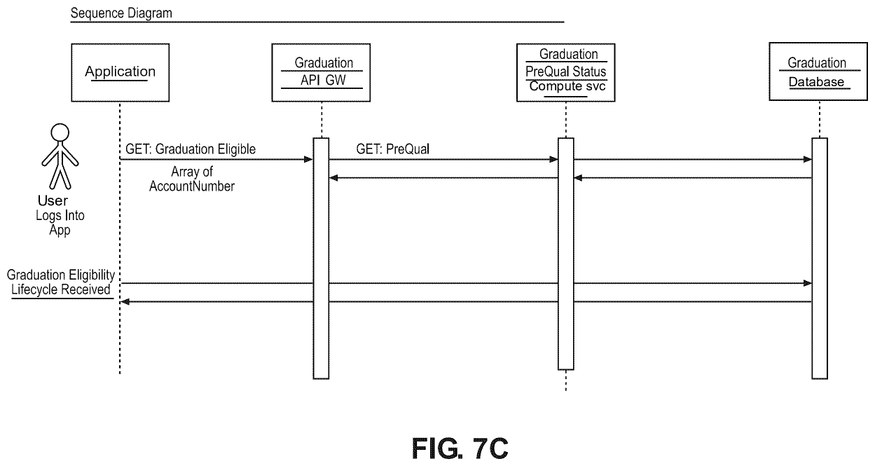

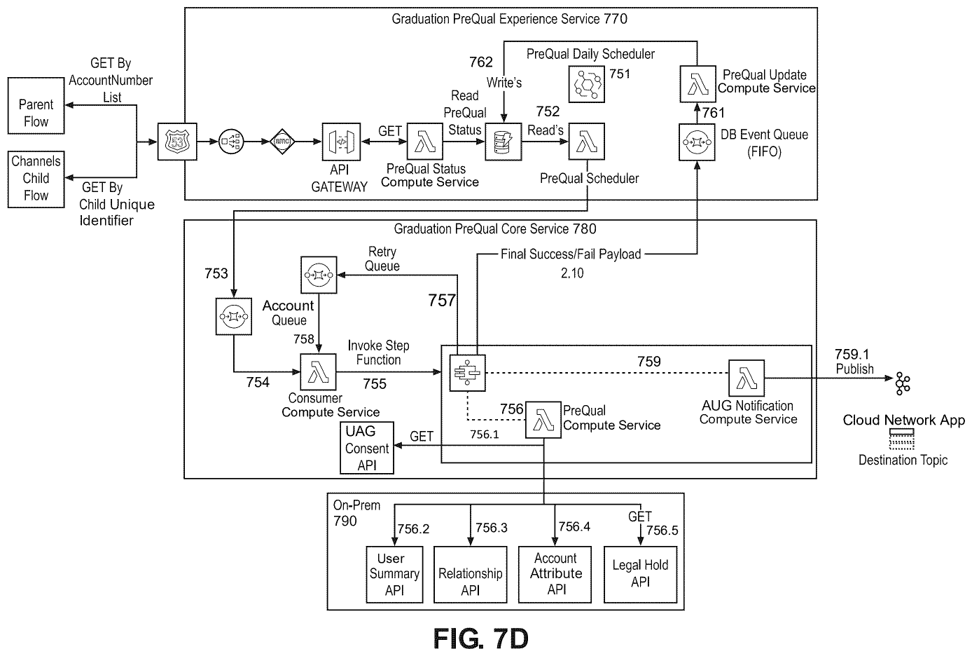

Detailed descriptions of an example performance of pre-qualification checks are provided with respect to FIGS. 7A-7D below.

In operation 403, for each of the eligible accounts identified in operation 403, a corresponding authorizing user or guardian (AUG) is identified, and then notified to request consent for converting the eligible account of the account holder (AH). In an example, the authorizing user or guardian may be a parent, and the account holder may be a child of that parent. However, aspects of the present disclosure may not be limited thereto, such that the authorizing user or guardian may be a supervisor, and the account holder may be a junior employee. In addition examples, the authorizing user or guardian may be a legal guardian, another person that may have co-signed for the account holder, a government official, a person of authority in an organization or the like. In an example, for graduation eligible accounts, the account holder may be indicated as a user of the account, whereas the corresponding authorizing user or guardian may be designated as an owner. For example, a minor, such as a user below the legal age, may be indicated as an account holder of an account while the minor's guardian or parent may be indicated as an owner of the minor's account.

Moreover, in an example, the corresponding authorizing user or guardian may be contacted by preferred account information specified by each of the authorizing user or guardian. For example, the authorizing user or guardian may request to be contacted by email, phone call, text message, or a combination of multiple communications. In addition to the above, further to the authorizing user or guardian, corresponding account holder may also be notified of the contacting of the authorizing user or guardian in accordance with their preferred contact information.

According to further aspects, the request for consent may have an expiration period that may be trigger upon sending of the request for consent. In an example, the expiration period may be a day, a number of days, a week or the like.

In operation 404, a consent of the authorizing user or guardian for authorizing graduation of the eligible account is captured, and a notification of such capture is transmitted to the account holder. In an example, the consent may be provided by a mobile application or other computing application. However, depending on security requirements, the consent may be required to be provided at an ATM that is equipped with various sensors (e.g., image sensors, microphones, finger print reader, and/or other biometric sensors) for verification of identity of the authorizing user or guardian prior providing of such consent.

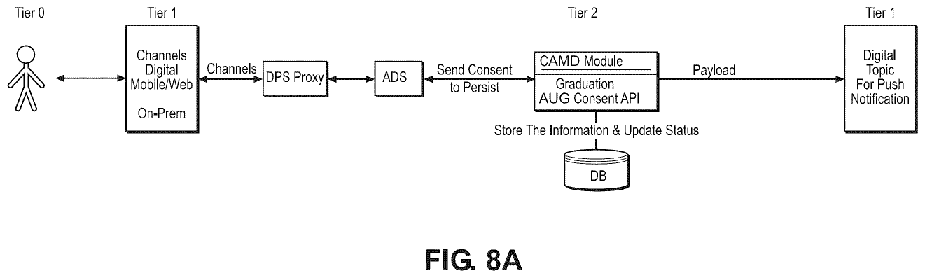

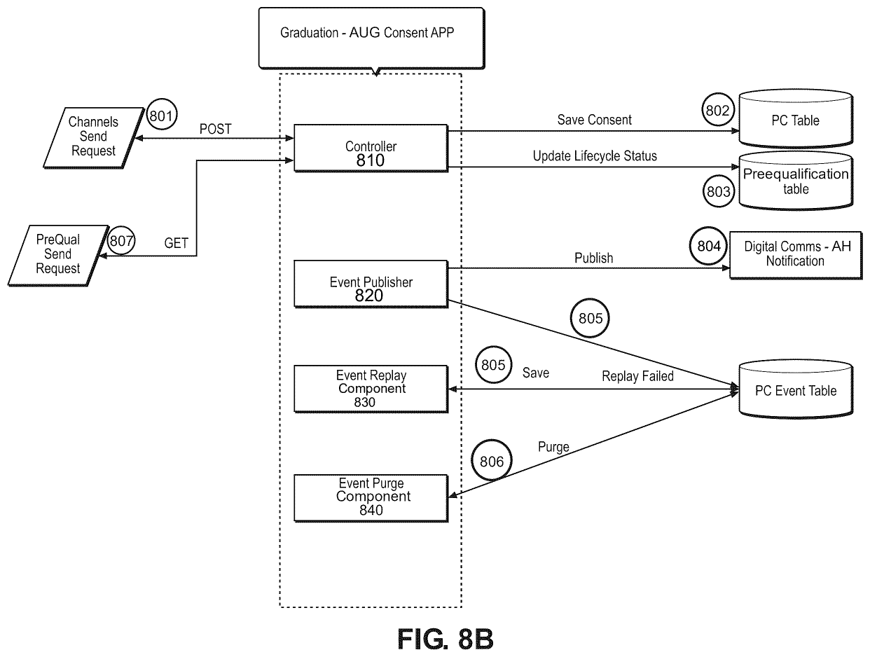

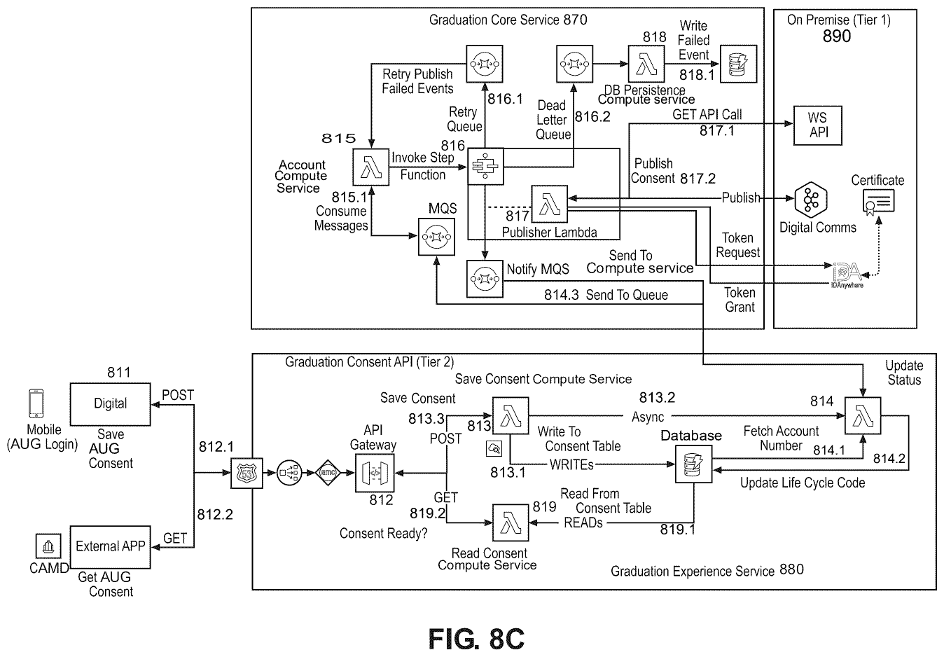

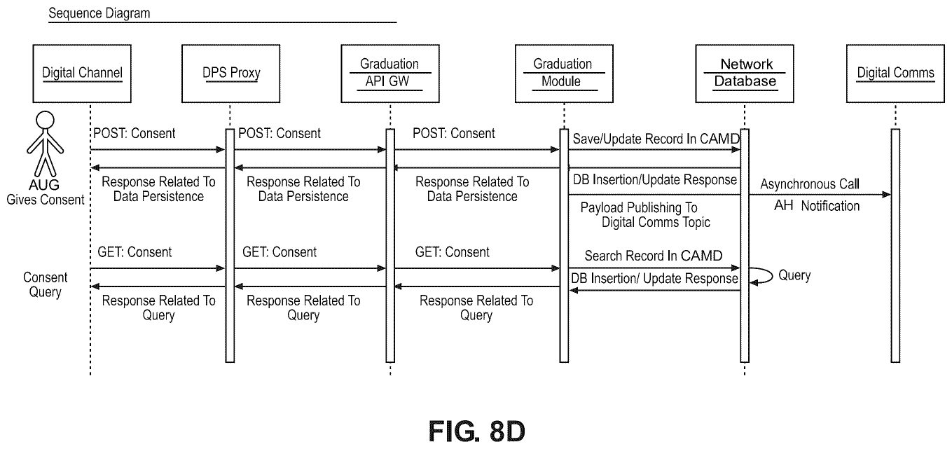

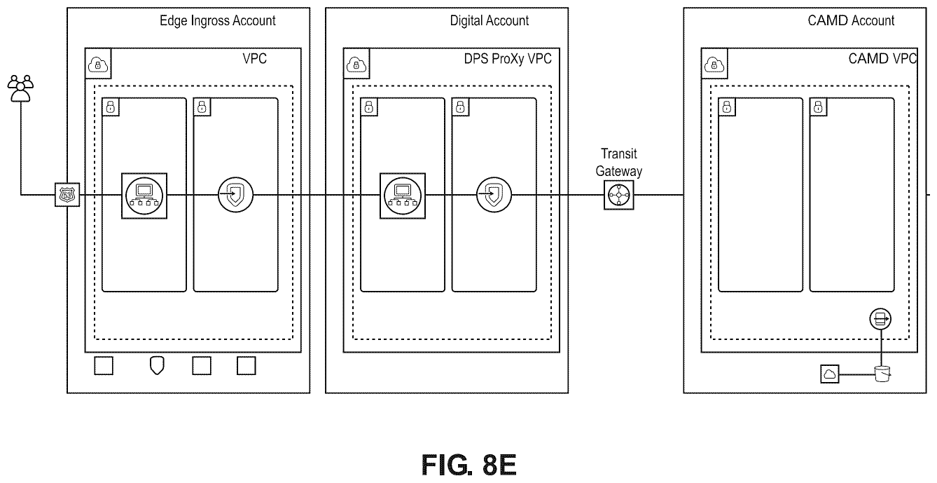

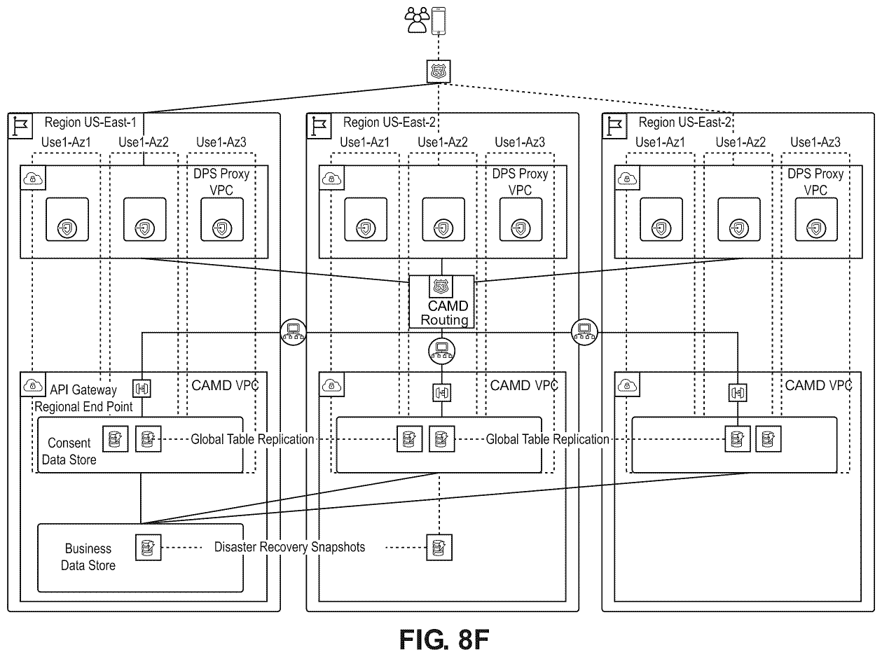

Detailed descriptions of a system performance example of obtaining consent of the authorizing user or guardian are provided with respect to FIGS. 8A-8F below.

In some embodiments, once the account holder receives notification, the account holder may select one or more products for implementation upon graduation of the eligible account. In this regard, the account holder may provide his or her proof of identification and/or provide personal information as part of the identification process of the account holder, which may include fraud and risk assessments. Based on risk models, authorization may be optionally performed. If the account holder does not qualify for one or more of the selected products, a counteroffer for a different product or a lower-tier product may be provided.

In operation 405, graduation of the eligible account is performed by modifying one or more parameters of the account without requiring closing of the eligible account and without opening of a new account. In an example, ownership information of the graduated account may be modified to indicate the account holder, and any relationship between the graduated account and the authorizing user or guardian is severed to terminate access by the authorizing user or guardian. Moreover, one or more restrictions may be removed from the previously restricted account. Upon graduation of the eligible account, both the account holder and the authorizing user or guardian are notified in accordance with their preferred communication methods or channels.

At least since a previously existing account is converted, as opposed deleting an old account and opening a new account as conventionally performed, one set of computing operations is required as opposed to two, providing for more efficient processing. Moreover, at least since the account information retains its memory location, data path to the account may remain the same requiring less updates to the system for further efficiencies of computing resources.

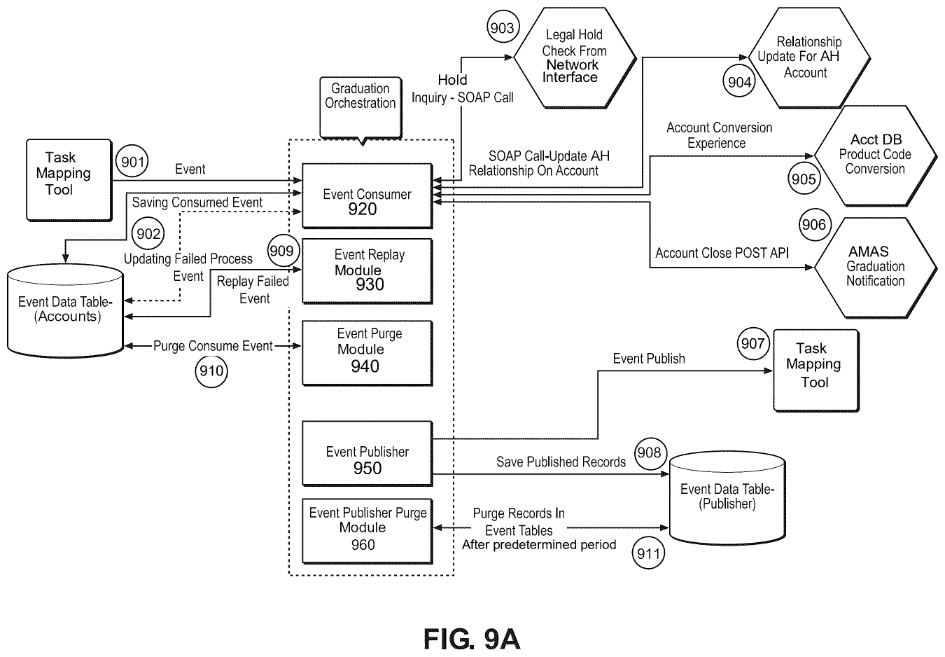

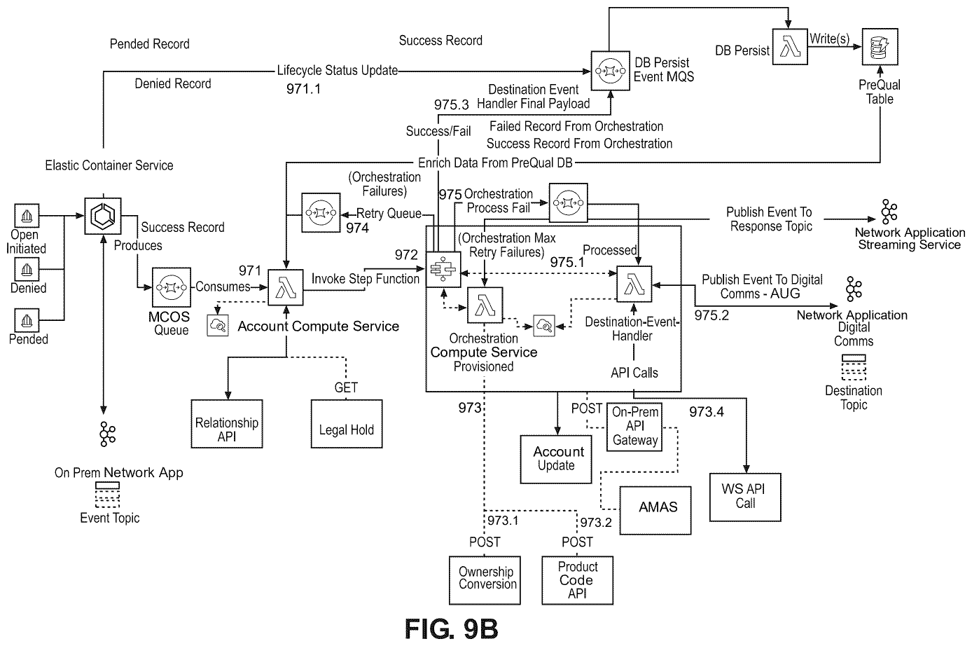

Detailed descriptions of a system performance example of graduating an eligible account are provided with respect to FIGS. 9A-9B below.

In operation 406, upon graduation of the eligible account and notification of the authorizing user or guardian, account authority, relationship to the account, access to the account and any other account related information may be terminated. Moreover, in an example, the authorizing user or guardian's access to the account may include issuance of a new card and/or access information, such as personal identification number, password, or the like.

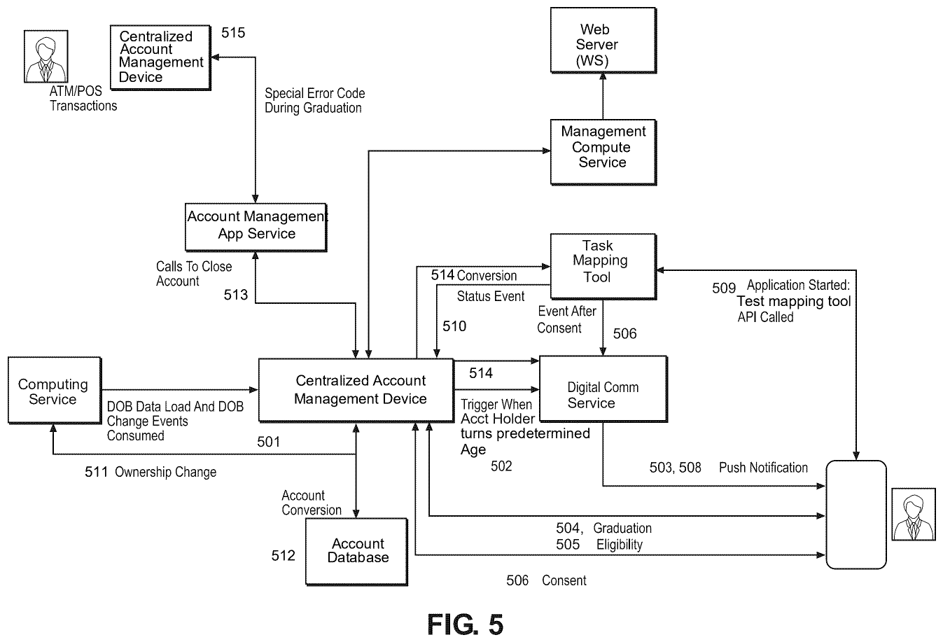

FIG. 5 illustrate system flows of a seamless graduation system for converting a restricted account to an unrestricted or less restricted account in accordance with an embodiment.

In operation 501, a computing service performs a DOB data load as into a centralized account management device, which consumes the DOB data load as a change event. In an example, the centralized account management device may be included in the seamless graduation system described above. Although DOB event is described herein, aspects of the present disclosure are not limited thereto, such that the triggering event may be related to a duration of residency, an expiration of a probationary period, a change in a user parameter, a change in an account and the like.

In an example, the computing service may perform a check on the DOB data according to a predetermined frequency (e.g., daily, weekly, monthly or etc.) for identifying accounts of eligible age account holders and performing the DOB data load. However, aspects of the present disclosure are not limited thereto, such that the check on the DOB data may be performed in response to a certain event, such as a usage of an ATM for performing an ATM transaction, logging into an application or the like.

Further, in response to consuming the DOB data load, the centralized account management device determines an age of a corresponding user or account holder. According to aspects of the present disclosure, the DOB data may be compared against the current date for determining an age of an account holder. In an example, the computing service may perform the DOB data load when a difference between the current date and the DOB data of the account holder indicates that the account holder is of a certain required age, such as a legal age (e.g., eighteen) in a respective jurisdiction.

Moreover, once the age of the user or account holder is determined to be of a certain age, the centralized account management device may perform one or more prequalification checks to ensure other requirements are met. In an example, the prequalification checks may be performed on a predetermined frequency until all of the prequalification requirements are met. According to aspects of the present disclosure, one or more prequalification may include, without limitation, a current mailing address, an amount of deposit, a duration of residency and the like.

In an example, the centralized account management device may be a computing device and may be included in the seamless graduation system. The centralized account management device may be connected to various compute services, APIs and other network components for facilitating the account graduation process. The centralized account management device may also be connected to a network database for storing various values during the graduation process, such as consent, lifecycle status, prequalification status, age status, and the like. The centralized account management device may also store the various values internally in its tables.

In operation 502, the centralized account management device, after its verification of age and prequalification requirements for determination of graduation eligibility of an account of the account holder, transmits the DOB event to the digital communication service.

In operation 503, the digital communication service performs push notification to an authorizing user or guardian of the graduation eligible account. In an example, for graduation eligible accounts, the account holder may be indicated as a user of the account, whereas the corresponding authorizing user or guardian may be designated as an owner. For example, a minor, such as a user below the legal age, may be indicated as an account holder of an account while the minor's guardian or parent may be indicated as an owner of the minor's account.

In operation 504, the authorizing user or guardian may receive the notification indicating the graduation eligibility of the account of the account holder. In an example, the authorizing user or guardian may receive the notification when a management compute service calls the centralized account management device to obtain information on the change event or the DOB event.

In operation 505, a mobile device of the authorizing user or guardian calls the centralized account management device to show the notification message to the authorizing user or the account holder when a restricted account becomes eligible for graduation.

In operation 506, the centralized account management device, a consent provided by the authorizing user or guardian is stored in a network database connected to the centralized account management device or in a table of the centralized account management device.

In operation 507, the centralized account management device publishes the change event or the DOB event for the account holder after the consent from the authorizing user or guardian is captured. The notification for the account holder is then consumed by the digital communication service.

In operation 508, the digital communication service performs a push notification to the account holder using one or more communication channels.

In operation 509, the account holder may start an application for graduating the graduation eligible account by calling a task mapping tool API via a mobile device or other computing device.

In operation 510, the graduation application is submitted, and the change event from the task mapping tool is consumed by the centralized account management device.

In operation 511, the centralized account management device calls a compute service to update ownership information or data of the graduated account.

In operation 512, the centralized account management device calls the account database to update a produce code or sub-product code according to a selection or input provided by the account holder during graduation of the graduation eligible account.

In operation 513, the centralized account management device calls a related account management application service to close a management application for the graduation eligible account. According to example aspects, the management application may be applied to the graduation eligible account when the respective account is created prior to the account holder reaching a predetermined age, such as legal age. However, the management application may be separate from the underlying account.

In operation 514, the centralized account management device publishes the change event for the conversion status of the graduation eligible account. In an example, the change event may indicate that the graduation eligible account, which may have one or more restrictions, has been converted to a graduated account, which may remove one or more restrictions present in the graduation eligible account. The task mapping tool may then consume the published event.

In operation 515, during the graduation process, a centralized security computing service may call the account management application service for transactions conducted at an ATM or point-of-sale (POS) using the graduation eligible account to return a special error code. In an example, the graduation process may include issuance of a new card (e.g., key card, debit card or etc.) or access information, such as personal identification number, passcode, password or the like. In this regard, if a new card is issued, the new card may become associated with the graduated account, and the previously issued card may continue working for a predetermined period of time or until the new card is activated.

FIGS. 6A-6B illustrate system flows for performing data loading operation in accordance with an embodiment.

FIG. 6A illustrates a file and event based application for storing data into a networked database in accordance with an embodiment. In an example, the networked database may be a NoSQL database provided by a webservice. The networked database may offer a fast persistent key-value datastore with built-in support for replication, autoscaling, encryption at rest and on-demand backup. Further, the networked database may be offered on a cloud network.

In an example, data load for performing a seamless transition of accounts includes a framework of multiple components. The framework may include a scheduler 610, an event consumer 620, an event replay 630 and an event purge 640. According to aspects, each of the scheduler 610, the event consumer 620, the event replay component 630 and the event purge component 640 may be implemented via a software component executed via an integrated circuit.

As illustrated in FIG. 6A, in operation 601, an input file may be uploaded to a network data storage. According to example aspects, the network data storage may store data objects, including files and corresponding metadata. In operation 602, a centralized account management device reads and processes the input file from the network data storage via the scheduler 610. According to aspects, operation 602 may trigger corresponding sub-processes, such as operation 602.1 and operation 602.2. In operation 602.1, the centralized account management device saves the successfully processed record in its database. In an example, the processed record is stored in a graduation eligibility table. In operation 602.2, the centralized account management device pushes an output file to the network data storage service after processing the input file via the scheduler 610 with status of a corresponding record processed.

In operation 603, the centralized account management device may listen to party-to-account relationship event for any new account addition, such as the graduation account. More specifically, the centralized account management device may listen to the party-to-account relationship event via the event consumer 620. According to aspects, operation 603 may trigger corresponding sub-processes, such as operation 603.1, operation 603.2 and operation 603.3. In operation 603.1, the centralized account management device saves the party-to-account relationship event in a database. In an example, the party-to-account relationship event is saved in a graduation event party-account relationship change table.

In operation 604, the centralized account management device replays any failed event marked in the database via the event replay component 630. However, aspects of the present disclosure are not limited thereto, such that the event marked successful in the database may be alternatively replayed or together with the failed events. In operation 605, the centralized account management device purges saved events after a predetermined period of time to conserve memory storage via the event purge component 640. In an example, the predetermined period of time may be a predetermined period, such as several days, a week or a month. However, aspects of the present disclosure are not limited thereto, such that the memory storage may be purged as determined by a machine learning model for more efficient management of the memory storage.

FIG. 6B illustrates one time data load and real-time relationship change processing in accordance with an embodiment.

In operation 650, a computing device or a cloud platform device may transfer an input file to a network data storage service. In example, the input file may be provided to the network data storage service via a file transfer protocol secure (FTPS) service. Moreover, a network glue service may perform processes for discovering, document, and visually mapping out services/devices on a network. Further, the input file may additionally be stored in a network database for performing prequalification monitoring via monitoring service logs for an account corresponding to or included in the input file. In an example, the networked database may be a NoSQL database provided by a webservice. The networked database may offer a fast persistent key-value datastore with built-in support for replication, autoscaling, encryption at rest and on-demand backup. Further, the networked database may be offered on a cloud network.

In operation 651, the centralized account management device may read or acquire customer party account relationship change event using on-premise distributed streaming services. The on-premise distributed streaming services may include recon topic and originating topic. Moreover, the centralized account management device may also retrieve DOB information from a user summary API, and may also obtain one or more account parameters from the account lookup API.

In operation 652, the centralized account management device sends the customer party account relationship change event with the obtained DOB and the one or more account parameters to the new account queue. In an example, the new account queue may have a visibility timeout setting, which may specify a predetermined timeout period. Moreover, one or more events from the on-premise distributed streaming services may be stored in a networked recon database.

In operation 653, the new account queue may receive customer party account relationship change event from the new account computing service. In an example, the new account queue may have a maximum receive count for receiving the customer party account relationship change event. Once the maximum receive count has been reached, the respective event is sent to a temporary message queue. In an example, the temporary message queue may temporarily store messages that are unable to be processed due to errors or other issues.

In operation 654, the new account computing service may insert the properly processed customer party account relationship change events into the network database for performing prequalification monitoring for graduation of an eligible account.

FIGS. 7A-7D illustrate system flows for performing prequalification check operation in accordance with an embodiment.

According to example aspects, prequalification check operation may be implemented via an API service. More specifically, the API service may provide two types of GET endpoints where the flow goes. The first type of GET endpoint may be a GET function by an account number. The second type of GET endpoint may be a GET by an electronic transaction type indicator (ETTI).

According to aspects, the GET function by account number may involve an operating system sending a request to GET or obtain prequalification or eligibility status of an account through a prequalification application of the centralized account management device. More specifically, the prequalification application of the centralized account management device may authenticate and authorize the received request with an active directory service (ADS) token authorization. Secondly, the centralized account management device may process the request with a corresponding account number and updates the prequalification table on a network database with the eligibility status and lifecycle status code in the prequalification table. In an example, the eligibility status may indicate whether or not an account is eligible to transition to a graduated or unrestricted account. In this regard, the eligibility status may indicate which parameters meet the prequalification requirements, and which may be deficient. The lifecycle status code may indicate a current step among the multiple steps that are to be processed for completing the account graduation. For example, the lifecycle status code may indicate that an authorizing user or guardian has been notified to request consent. Thirdly, the centralized account management device publishes encrypted eligibility event to the digital communication for triggering parent notification.

According to further aspects, the GET function by ETTI may involve one or more channels sending a request to GET or obtain prequalification or eligibility status of the ETTI through the prequalification application of the centralized account management device. More specifically, the prequalification application of the centralized account management device may authenticate and authorize the received request with the ADS token authorization. Secondly, the centralized account management device may process the request with a corresponding ETTI, and updates the prequalification table in the network database with the eligibility status and lifecycle status code. Thirdly, the centralized account management device publishes encrypted eligibility event to the digital communication for triggering account holder notification.

FIG. 7A illustrates a conceptual diagram of the prequalification check operation summarized above.

As illustrated in FIG. 7A, a request to GET or obtain prequalification or eligibility status of an account may be transmitted via one or more channels, such as digital, mobile or web via a deployment proxy service (DPS). In an example, the DPS may be provided to broker software infrastructure of Tier 1 service with that of Tier 2 service to perform a GET function. The GET function may log into the Tier 2 service's ADS, which may access the centralized account management device via the ADS token authorization to retrieve a prequalification status of a respective account. The centralized account management device, upon validation, processes the request and updates the prequalification table in the network database with an eligibility status and lifecycle status code. Then the centralized account management device publishes an encrypted event to provide a notification to an end user device, such as a device of an authorizing user or guardian and a device of the account holder.

FIG. 7B illustrates a flow chart of the prequalification operation.

In operation 701, the scheduler 710 of the centralized account management device reads or fetches account data for which age value is 18 or greater. In operation 702, the scheduler 710 processes the account data to check eligibility criteria. In an example, a primary eligibility criteria may be age. However, other eligibility criteria may be present. For example, eligibility criteria may include residency requirements, physical address requirement, account parameter value requirement and/or the like. However, aspects of the present disclosure are not limited thereto, such that the primary eligibility requirement may be set to a different value, and differing number of eligibility requirements may be present based on the account to be graduated.

Further, operation 702 may trigger corresponding sub-processes, such as operation 702.1, operation 702.2, operation 702.3, operation 702.4 and operation 702.5. In operation 702.1, the centralized account management device may call the user summary API to get the DOB value in the account and validate against an existing value. Further, if the DOB value is different than the existing value, the network database is updated to reflect the DOB value. In operation 702.2, the centralized account management device may call an account relationship API to check various parameters associated with the respective account, such as the account status, another account linked with the graduation eligible account, account open date and the like. In operation 702.3, the centralized account management device may call an account inquiry API to obtain account parameters. In operation 702.4, the centralized account management device may perform a check to determine if any hold, such as legal hold, is placed on an account of the authorizing user or guardian associated with the graduation eligible account. In operation 702.5, once results of operation 702.1, operation 702.2, operation 702.3 and operation 702.4 are deemed satisfactory, the centralized account management device may call the guardian consent API to obtain consent from the authorizing user or guardian.

In operation 703, the centralized account management device may update the eligibility status in the prequalification or eligibility table. In operation 704, graduation event is pulled from a relevant table, such as graduation eligibility table, and published to the digital communication via the event publisher 730 to send push notification to the authorizing user or guardian. Further, operation 704 may trigger corresponding sub-processes, such as operation 704.1 and operation 704.2. In operation 704.1, the event publisher 730 publishes the graduation event for digital communication. In operation 704.2, if the published event fails, the event publisher 730 saves the published failed event in a network database.

In operation 705, the service eligibility determination component 720 of the centralized account management device will be called by the prequalification API to respond back with an eligibility status.

FIG. 7C illustrates a sequence diagram of the prequalification operation.

As illustrated in FIG. 7C, an account holder may log into his or her application, which triggers a cloud or network application to perform a GET function for determining graduation eligibility of an account of the account holder. The GET function is provided with an array of account numbers. In response, a graduation API will GET or obtain prequalification status of the account of the account holder from a graduation prequalification status serverless compute service, which in turn queries a corresponding network database for obtaining and retrieving prequalification information for the account of the account holder and providing the retrieved information to the account holder.

Although the account holder is described as logging into his or her application via a computing device, aspects of the present disclosure are not limited thereto, such that obtaining or GET function for graduation eligibility may be performed at an ATM after being verified. For example, in response to performance of an ATM transaction, a user's DOB may be checked against the current ATM transaction date for determining whether to perform the GET function for graduation eligibility. Further, a user may be verified by an image captured by an image sensor, a voice input captured by a microphone, a finger print captured by a biometric reader and the like. Once the user is determined to be eligible in terms of age, the ATM may initiate the GET function over a network.

In FIG. 7D illustrates a cloud solution for performing the prequalification operation.

As illustrated in FIG. 7D, the cloud solution involves interaction between three tiers of services, namely the graduation prequalification experience service 770, the graduation prequalification core service 780 and on-premise services 790.

In operation 751, an event bridge invokes a prequalification scheduler serverless computing service according to a predetermined schedule. In an example, the predetermined schedule may be set to daily basis.

In operation 752, the prequalification scheduler serverless computing service obtains data from a network database based on a predetermined criteria, such as age.

In operation 753, the prequalification scheduler serverless computing service sends all of the eligible records to an account queue.

In operation 754, the account queue invokes an account compute service with payload for further processing.

In operation 755, the account queue invokes a step function with payload for further processing. The step function starts a workflow by invoking a prequalification processor compute service.

In operation 756, the prequalification processor compute service checks the eligibility criteria and communicate back to the step function. The checks may include performance of operation 756.1, operation 756.2, operation 756.3, operation 756.4 and operation 756.5. The operation 756.1 includes calling an authorizing user or guardian API. The operation 756.2 includes calling a user summary API. The operation 756.2 includes calling a change relationship API. The operation 756.4 includes calling an account attribute API. The operation 756.5 includes calling a legal hold API. As result of the checks, payloads may either be successfully processed or fail.

In operation 757, failed payload is sent to a retry queue for execution.

In operation 758, failed payload in the retry queue is sent to the account queue for reprocessing the previously failed payloads. In an example, a failed payload may be sent to the retry queue for a predetermined number of times before being saved as a failed payload.

In operation 759, the authorizing user or guardian notification processor compute service is invoked with eligible payloads. Further, in operation 759.1, the notification for the authorizing user or guardian for the eligible payloads are published a cloud or network application for distribution to the respective authorizing users or guardians.

In operation 760, final successfully processed payloads and failed payloads are saved in a network database and placed in a database event queue. In an example, the database event queue may be queued in a first-in-first-out (FIFO) order.

In operation 761, the queued payloads are sent to the prequalification update compute service for writing into a network database, which is then saved in the network database in operation 762.

FIGS. 8A-8F illustrate system flows for obtaining and processing a consent of an authorizing user or guardian in accordance with an embodiment.

According to aspects of the present disclosure, once a restricted account is eligible for graduation, a notification may be sent to an authorizing user or guardian for the eligible account. The notification may be provided as a push notification, and may state that the restricted account is eligible for graduation and that the authorizing user or guardian has to provide consent to proceed with the graduation process. If the respective authorizing user or guardian provides the consent, the centralized account management device saves the provided consent in its database with an expiration date. Further, once the necessary consent is provided by the authorizing user or guardian, then the account holder for the restricted account eligible for graduation is also notified.

According to aspects, consent may be provided via an application or a mobile device. However, aspects of the present disclosure are not limited thereto, such that based on the security requirements for graduation of the restricted account, verification for the authorizing user or guardian may be required to be performed at a nearby ATM that may be equipped with one or more biometric sensors for providing such verification prior to providing consent.

FIG. 8A illustrates a concept diagram for providing an authorizing user's or guardian's consent.

As illustrated in FIG. 8A, authorizing user or guardian consent may utilize two APIs (labeled as Tier 1) for respectively performing the GET function and the POST function. The seamless graduation system or centralized account management device may send a request to receive a consent to authorizing users or guardians via one or more channels, such as digital, mobile or web via the DPS proxy. In an example, the DPS may be provided to broker software infrastructure of Tier 1 service with that of Tier 2 service. In an example, the request may be a POST function request. The POST function requestion may authenticate and authorize each request with an ADS token authorization from one or more headers from the request.

Once the authorizing user or guardian provides his or her consent, the centralized account management device saves the consent along with its expiration date in its respective database or table. In an example, one or more external application may sent the GET request and may inquire on the consent by providing, for example, an enterprise account identifier (EAI). Further, upon saving of the consent, the centralized account management device may publish an encrypted data event to digital communication for providing notification to the account holder of the restricted account that is eligible for graduation. Subsequently, the centralized account management device may update the lifecycle status of the account graduation table stored in a network database.

FIG. 8B illustrates a flow chart for the providing of the authorizing user's or guardian's consent.

In operation 801, a request for consent by an authorizing user or guardian is sent via one or more channels by calling a consent API to persist the record. In an example, the request may be sent as a POST function to the controller 810.

In operation 802, the centralized account management device saves the received consent via the controller 810 in a network database. The table storing the received consent may not be purged, as unlike a newly created unrestricted account, the account is a graduated account.

In operation 803, the centralized account management device updates, via the controller 810, the lifecycle status of both the account holder and the corresponding authorizing user or guardian after the consent is received.

In operation 804, the centralized account management device saves the event to be published in the network database, and publishes a notification event to the digital communication service to be delivered to the account holder of the graduation eligible account via the event publisher 820.

In operation 805, the centralized account management device re-publishes the event in case of any failures while performing the initial publishing via the event replay component 830.

In operation 806, the centralized account management device purge the published events from the network database which are older than a predetermined period, such as 30 days, via the event purge component 840.

In operation 807, centralized account management device, via the controller 810, respond to the GET request by searching existing data in a data table. In an example, the GET request may be a request for prequalification of the graduation eligible account.

FIG. 8C illustrates an architectural solution diagram for the providing of the authorizing user's or guardian's consent.

As illustrated in FIG. 8C, the architectural solution involves interaction between three tiers of services, namely the graduation core service 870, graduation experience service 880 and on-premise services 890.

In operation 811, a task mapping tool sends a POST request to the consent API via a cloud API gateway.

In operation 812, two sub-processes are performed as operation 812.1 and operation 812.2. More specifically, the cloud API gateway invokes a ‘save consent’ computing service as operation 812.1, and invokes a ‘read consent’ computing service in operation 812.2.

In operation 813, three sub-processes are performed as operation 813.1, operation 813.2 and operation 813.3. In operation 813.1, the ‘save consent’ computing service writes parental consent to the network database table. In operation 813.2, the ‘save consent’ computing service asynchronously invoke an ‘update status’ computing service. In operation 813.3, the ‘save consent’ computing service sends response back to the cloud API gateway. According to example aspects, once the consent provided by the authorizing user or guardian is saved or written to the network database table, the account holder may be given a predetermined period of time (e.g., one or more weeks or months) to initiate the graduation process. If the account holder does not initiate the graduation process within the predetermined period of time, the consent provided by the authorizing user or guardian may be deemed stale and no longer valid, and another request is sent to the authorizing user or guardian for receiving a new or fresh consent.

In operation 814, three sub-processes are performed by the ‘update status’ computing service as operation 814.1, operation 814.2, operation 814.3. In operation 814.1, the ‘update status’ computing service fetches the account number of the graduation eligible account from a prequalification table. In operation 814.2, the ‘update status’ computing service updates the lifecycle status for both the account holder and the authorizing user or guardian. In operation 814.3, the ‘update status’ computing service fetches the account holder's unique identifier and append the account number and the account holder event to save the consent event.

In operation 815, account compute service listens to messages from the message queue service (MQS), and invokes the step function in operation 815.1.

In operation 816, two sub-processes are performed as operation 806.1 and operation 816.2. In operation 816.1, the step function may push failed events to the retry queue. In operation 816.2, the step function may push failed events to dead letter queue after a predetermined number of retries.

In operation 817, two sub-processes are performed as operation 817.1 and operation 817.2. In operation 817.1, the publisher computing service may publish events to make a call to a web service to obtain the account holder's online profile identifier. In operation 817.2, the publisher computing service may publish events to digital communication service for notifying the account holder.

In operation 818, the database persistence computing service will write to the network database. In operation 818.1, failed events may be written to the network database for auditing.

In operation 819, two sub-processes are performed as operation 819.1 and operation 819.2. In operation 819.1, the read consent computing service may retrieve data from the network database. In operation 819.2, the read consent computing service may respond back with a response to the cloud gateway.

FIG. 8D illustrates a sequence diagram for the providing of the authorizing user's or guardian's consent.

As illustrated in FIG. 8D, the authorizing user or guardian provides consent via a digital channel, which is then relayed via the DPS proxy to be transmitted through a graduation API gateway towards a graduation module, such as the centralized account management device. In an example, the graduation API gateway and/or the graduation module may be cloud based. Once the transmitted consent is processed by the cloud graduation module, a corresponding data record is saved or updated in a network database connected to the centralized account management device. Once the data record is inserted or updated in the network database, a response message is sent from the network database to the graduation module.

The graduation module transmits a distributed streaming service payload to the network database. The network database then performs an asynchronous call to the digital communication service for transmitting a notification message to the account holder. In an example, the notification message may be transmitted via one or more communication channels based on available contact information of the account holder.

The graduation module also transmits a response related to data persistence to the graduation API gateway. The graduation API gateway, then transmits the response related to data persistence to the DPS proxy, which then relays the response related to data persistence back to the authorizing user or guardian via one or more channels.

As further illustrated by FIG. 8D, a query with respect to the consent of the authorizing user or guardian may be by the account holder or by an account managing organization. In this aspect, a request to perform GET function for the consent of the authorizing user or guardian is sent to the graduation API gateway via the DPS proxy. The graduation API gateway then transmits the GET function to the graduation module, which then searches the network database for the consent data record. Once the query is performed, the network database sends a database insertion/update response to the graduation module. The graduation module, in turn, sends a response related to the query back to the querying device or application via the graduation API gateway, the DPS proxy and one or more communication channels.

FIG. 8E illustrates an infrastructure diagram for the providing of the authorizing user's or guardian's consent.

As illustrated in FIG. 8E, account graduation consent is a component under the centralized account management device with no existing footprint on-premise network. According to aspects of the present disclosure, the account graduation consent solution may be provided on a cloud network, and may connect to the cloud graduation module, such as the centralized account management device, via a transit gateway. Further, data received may be persisted in a database tables corresponding to the centralized account management device.

FIG. 8F illustrates a network diagram for the providing of the authorizing user's or guardian's consent.

As illustrated in FIG. 8F, a user device may connect to various devices in different regions via a domain name system (DNS) web service routing. More specifically, a user device may access, via one of several DPS proxies provided at different regions, one of many virtual private clouds or virtual networks supported by an infrastructure located in different regions. More specifically, once the user device connects to one of the DPS proxies, the user device may be routed, via the DNS web service routing, to one of the virtual private clouds for processing by a centralized account management device. In an example, each of the virtual private clouds may include replicated global tables that store consent provided by an authorized user or guardian.

FIGS. 9A-9B illustrate system flows for performing a graduation of an eligible account in accordance with an embodiment.

According to example aspects, once the account holder has gone through a user identification or verification process, the account of the account holder may proceed to graduation or conversion via a digital channel or a task mapping tool.

Generally, upon receiving an event from the task mapping tool or the digital channel, the centralized account management device may process the data record. More specifically, the centralized account management device may first confirm whether the received event is a failed or successfully processed event. In an example, for failed events, lifecycle status may be updated to reflect to failed event. On the other hand, for successfully processed events, the centralized account management device may check for presence of a legal hold (or any other holds) on the authorizing user's or guardian's account. If the legal hold is determined to be present, a failed event may be published back to the task mapping tool with the reason of legal hold being specified. If no legal hold is determined to be present, ownership information is updated for the graduated account from the authorizing user or guardian to the account holder. The successfully graduated or converted account may cause the centralized account management device to publish the successful conversion event to a distributed streaming service for consumption by the task mapping tool. Subsequently, eligibility status and the lifecycle status may be updated in its respective table or network database. Lastly, distributed streaming service event is published to digital communication service to send push notification to the respective authorizing user or guardian to notify that the graduation is complete for one of their linked accounts.

FIG. 9A illustrates a data flow diagram for performing a graduation of an eligible account in accordance with an embodiment.

In operation 901, the event consumer 920 of the centralized account management device consumes events published by the task management tool. In operation 902, the event consumer 920 of the centralized account management device saves the consumed event with a corresponding status, such as consumed. In operation 903, the event consumer 920 of the centralized account management device calls a network interface to check presence of any legal holds (or any other holds) on the authorizing user or guardian. If any hold is present for the authorizing user or guardian, the data flow stops with the event updated to status of skipped, and updated in a network database.

In operation 904, the centralized account management device calls a computing service to update relationship for the graduated account. More specifically, the relationship for the graduated account from the authorizing user to the account holder. In an example, the authorizing user or guardian may be removed from the relationship information for the graduated account.

In operation 905, the centralized account management device calls the account database to update a product code or a sub-product code of the graduated account.

In operation 906, the centralized account management device calls account management application service (AMAS) designated for managing age restricted accounts, and closes the account management application service for the graduated account.

In operation 907, the centralized account management device may publish events for completed status and skipped status back to the task mapping tool.

In operation 908, the centralized account management device may save the published events in the network database.

In operation 909, the centralized account management device may replay failed consumed events via the event replay module 930. In an example, the centralized account management device may replay all of the failed events that fail due to any API or technical failure from the consumed events.

In operation 910, the centralized account management device may purge consumed events that are older than a predetermined period of time via the event purge module 940.

In operation 911, the centralized account management device may purge published events that are older than a predetermined period of time via the event publisher purge module 960.

FIG. 9B illustrates a performance tuned cloud solution architecture for performing a graduation of an eligible account in accordance with an embodiment.

In operation 971, a managed container orchestration service (MCOS) initially polls for new messages from a task mapping tool distributed streaming service based event source. Operation 971 includes operation 971.1, operation 971.2 and operation 971.3. In operation 971.1, the managed container orchestration service polls for new messages from the task mapping tool open account initiated topic and update lifecycle code, and also invokes a user compute service. In operation 971.2, the managed container orchestration service polls for new messages from the task mapping tool pending topic and update lifecycle status code, and also produce the received event to the managed container orchestration service queue. In operation 971.3, the managed container orchestration service polls for new messages from the task mapping tool denied topic and updates the lifecycle status code.

In operation 972, the user compute service consumes payload from the managed container orchestration service queue and invokes a step function. Operation 972 includes operation 972.1, operation 972.2 and operation 972.3. In operation 972.1, the user compute service performs a prequalification table call to obtain identification information and account number of an authorizing user or guardian. In operation 972.2, the user compute service performs a GET rest call to an account relationship API to obtain an account attribute or parameter. In operation 972.3, the user compute service performs the GET rest call to a network interface to check presence of legal hold for the authorizing user or guardian. If the legal hold is found to be present, the user compute service may skill all future calls and publish the event to the task mapping tool.

In an example, the step function invoked in operation 972 coordinates with the orchestration compute service and destination-event-handler compute service and help in maintaining flexible workflow that are easy to debug and also help in scheduled retry mechanism for failed scenarios, such as exceptions in processing an event.

In operation 973, the orchestration compute service process the event in synchronous calls outlined in operation 973.1, operation 973.2, operation 973.3, operation 973.4 and operation 973.5. In operation 973.1, the orchestration compute service performs a POST rest call to a computing service to change the relationship or ownership of the graduating account from the authorizing user or guardian to the account holder. In operation 973.2, the orchestration compute service performs the POST rest call to the account database to convert a product or sub-product code of the graduating account per selection by the account holder. In operation 973.3, if any of the above described API calls fail, the orchestration compute service invokes a step function to publish one or more messages to the retry queue, which may then be consumed by the user compute service for reprocessing. In operation 973.4, after a predetermined number of retries, if there are failures in API calls, a step function is invoked to publish messages to a dead letter queue. In operation 973.5, the orchestration compute service publishes success and fail events to the task mapping tool and the digital topics.

In operation 974, a step function may invoke a destination-event-handler with processed event details.

In operation 975, the destination-event-handler compute service may update lifecycles statuses for orchestration failures and for orchestration successes in a prequalification table. Operation 975 includes operation 975.1, operation 975.2 and operation 975.3. In operation 975.1, the destination-event-handler compute service performs a POST call to an account management application service to notify account closure. In an example, the account management application service may provide an application for the restricted account prior to graduation, which is separate from the underlying account itself. In operation 975.2, the destination-event-handler compute service performs a POST call to the account database to update the account holder's identification number on the graduated account. In operation 975.3, the destination-event-handler compute service performs a web service profile GET call to obtain a profile ID to publish the event for publishing a digital communication event to send a push notification to the authorizing user or parent upon successful graduation of the account.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing a seamless graduation of a restricted account, the method comprising:
scanning, one or more databases by a processor, for identifying a potential account for graduation based on a date of birth (DOB) data of an account holder;
performing, by the processor, one or more prequalification checks on the potential account for graduation for determining whether the potential account is a graduation eligible account;
identifying, by the processor, an authorizing user for the graduation eligible account;
notifying, by the processor via a digital communication service, the authorizing user of graduation eligibility of the graduation eligible account and requesting to receive consent from the authorizing user;
capturing, by the processor, the consent of the authorizing user for authorizing graduation of the graduation eligible account;
converting, by the processor, the graduation eligible account into a graduated account, wherein the graduated account is a modification of the graduation eligible account that is existing in a network database; and
terminating, by the processor, access to the graduated account by the authorizing user.

2. The method according to claim 1, wherein the scanning is performed in accordance with a predetermined frequency.

3. The method according to claim 1, wherein the potential account for graduation is identified based on a current date and the DOB of the account holder of the potential account.

4. The method according to claim 1, wherein the scanning for identifying the potential account for graduation is performed in response to an automated teller machine (ATM) transaction or one or more actions on a mobile application conducted by the account holder.

5. The method according to claim 1, wherein the authorizing user is set as an owner of the graduation eligible account, while the account holder is set as an authorized operator of the graduation eligible account.

6. The method according to claim 1, wherein the authorizing user is a legal guardian of the account holder.

7. The method according to claim 1, wherein the authorizing user provides the consent via an ATM, and wherein the ATM performs verification of the authorizing user using a plurality of sensors prior to receiving of the consent.

8. The method according to claim 1, further comprising:
notifying, by the processor, the account holder of a performance of the notifying of the authorizing user.

9. The method according to claim 1, further comprising:
saving, in permanence and by the processor in the network database, captured consent of the authorizing user.

10. The method according to claim 5, wherein the converting further comprises:
changing the account holder to be set as the owner; and
terminating relationship of the authorizing user from the graduation eligible account.

11. The method according to claim 1, wherein the converting is performed without creating a new account or deleting an existing account.

12. The method according to claim 1, wherein the graduation eligible account removes at least one restriction from the graduation eligible account.

13. The method according to claim 1, wherein the converting further comprises:
terminating, by the processor, a management application tied to the graduation eligible account.

14. The method according to claim 1, wherein the one or more prequalification checks includes checking of a presence of a predetermined amount of deposit.

15. The method according to claim 1, wherein the one or more prequalification checks includes checking of a duration of residency.

16. The method according to claim 7, wherein the plurality of sensors includes a biometric reader.

17. The method according to claim 7, wherein the plurality of sensors includes an image sensor and a microphone.

18. The method according to claim 1, wherein the graduation eligible account is a restricted account that was created prior to the account holder reaching a predetermined age.

19. A system for providing a seamless graduation of a restricted account, the system comprising:
a processor; and
a memory operatively connected to the processor via a communication interface, the memory storing computer readable instructions, when executed, causes the processor to perform:
scanning, one or more databases, for identifying a potential account for graduation based on a date of birth (DOB) data of an account holder;
performing one or more prequalification checks on the potential account for graduation for determining whether the potential account is a graduation eligible account;
identifying an authorizing user for the graduation eligible account;
notifying, via a digital communication service, the authorizing user of graduation eligibility of the graduation eligible account and requesting to receive consent from the authorizing user;
capturing the consent of the authorizing user for authorizing graduation of the graduation eligible account;
converting the graduation eligible account into a graduated account, wherein the graduated account is a modification of the graduation eligible account that is existing in a network database; and
terminating access to the graduated account by the authorizing user.

20. A non-transitory computer readable medium configured to store instructions for providing a seamless graduation of a restricted account, the instructions, when executed, cause a processor to perform operations of:
scanning, one or more databases, for identifying a potential account for graduation based on a date of birth (DOB) data of an account holder;
performing one or more prequalification checks on the potential account for graduation for determining whether the potential account is a graduation eligible account;
identifying an authorizing user for the graduation eligible account;
notifying, via a digital communication service, the authorizing user of graduation eligibility of the graduation eligible account and requesting to receive consent from the authorizing user;
capturing the consent of the authorizing user for authorizing graduation of the graduation eligible account;
converting the graduation eligible account into a graduated account, wherein the graduated account is a modification of the graduation eligible account that is existing in a network database; and
terminating access to the graduated account by the authorizing user.
